(19) United States
(12) Patent Application Publication
(10) Pub. No.: US 2014/0186580 A1
(43) Pub. Date: Jul. 3, 2014

(54) SURFACE COMPONENT FOR AN AIRCRAFT AND MANUFACTURING METHOD THEREOF

(71) Applicant: EADS DEUTSCHLAND GMBH, Ottobrunn (DE)

(72) Inventors: Markus J. WEBER, Hamburg (DE); Andreas WIELTSCH, Hamburg (DE)

(73) Assignee: EADS DEUTSCHLAND GMBH, Ottobrunn (DE)

(21) Appl. No.: 14/077,573

(22) Filed: Nov. 12, 2013

(30) Foreign Application Priority Data
Nov. 12, 2012 (DE) 10 2012 110 862.5

(51) Int. Cl. B64C 1/00

(52) U.S. Cl. CPC B64C 1/00
USPC 428/135; 428/138; 428/134; 156/60

(57) ABSTRACT

In order to provide a lightweight structure which can take up relatively large loads, the invention provides for a surface component for an aircraft, having at least one shell and a reinforcement grid structure, wherein the shell has a preliminary buckling structure which, under a load which acts on the shell in a direction parallel with the shell, brings about a buckling of the shell in a predetermined direction. A production method is further described.

The invention relates to a surface component for an aircraft, which surface component has at least one shell and a reinforcement grid structure. The invention further relates to a production method for such a surface component.

Such surface components are used, for example, for the construction of a fuselage structure of an aircraft, such as, for example, an airplane or a helicopter, or a spacecraft or the like. However, such surface components may also be used in other fields of aircraft, such as, for example, supporting surfaces or stabilizers, pressure bulkheads or in intermediate floors. Such surface components may also be used in other fields of application where a lightweight construction is important, such as, for example, in vehicle construction, ship-building or in construction engineering.

Surface components which are configured for aircraft and which are constructed from a reinforcement grid structure and at least one shell are known, for example, from DE 10 2009 013 511 A1, DE 10 2009 013 585 A1, DE 10 2009 048 748 A1, DE 10 2009 056 994 A1, DE 10 2009 056 995 A1, DE 10 2009 056 996 A1, DE 10 2009 056 997 A1, DE 10 2009 056 998 A1, DE 10 2009 056 999 A1, DE 10 2009 057 006 A1, DE 10 2009 057 009 A1, DE 10 2009 057 010 A1 and DE 10 2009 057 018 A1.

The known surface components are considered primarily as fuselage components for aircraft.

Aircraft fuselage cells for large airplanes are primarily formed with monolithic skin fields in airplanes which are currently commercially available. For reinforcement, a large number of longitudinal reinforcement members which extend spaced apart from each other parallel with the flight direction are provided internally on the monolithic skin fields. Furthermore, there are arranged at the inner side on the skin fields a large number of ring frames which are each orientated transversely relative to the flight direction. The monolithic skin fields which are reinforced in this manner are completed by way of the multi-shell construction method to form tub-like fuselage sections and subsequently joined together by being arranged one behind the other to form a complete airplane fuselage cell.

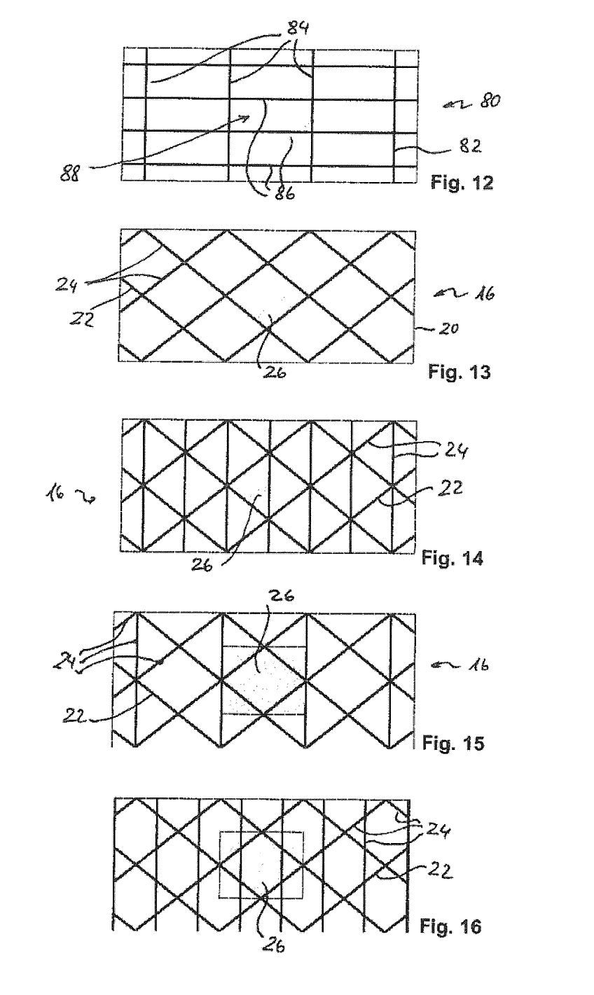

Such a reinforcement structure having reinforcements which extend in the longitudinal direction and in the peripheral direction of the fuselage is also referred to as a frame/stringer construction. An example of such a grid structure of such frame/stringer constructions is set out in FIG. 12. Rectangular skin fields are accordingly formed between the reinforcement grid structures.

In the types of airplane previously commercially available, both the shells and the reinforcement grid structures are primarily produced from metals. Only in recent times have composite fiber materials begun to be used both for the shells and for the reinforcement structures.

Examples of the use of such composite fiber structures and production methods and advantageous grid structures for the reinforcement structures are described in the documents mentioned previously.

Lightweight .structures are constructed for stability under pressure loading and under thrust loading. The so-called buckling leads in this case, from a specific load, to an abrupt deformation outside the plane of a reinforced plate or shell. This dynamic effect can lead to appearances of fatigue or, when profile-members are used on the skin, can lead to high peeling stresses and local bending moments.

The metal structures which are also still used today in aircraft construction can be configured in such a manner that the post-buckling region is included in order to exploit the pressure and thrust loading. The metal plates and shells, in the event of a thrust loading on the substantially cylindrical fuselage, are first buckled slightly outward and then reverse inward toward the reinforcement structures from a specific load. The corresponding dynamic absorption forces, even in the post-buckling region, can be incorporated in the construction in order to calculate the stability.

As a result of a possible material failure in the event of an abrupt deformation of composite fiber components, surface components having shells and reinforcement grid structures in the case of construction using a composite fiber construction method are not described in the so-called post-buckling region. Causal material failure may be in this instance breaks in the fiber and plastics matrix of the laminate and occurrences of delamination in the laminate and between the shell and the reinforcement profile-members.

For the following considerations, there is taken as a basis a frame/stringer construction for primary aircraft structures, such as the fuselage or supporting surfaces, as indicated in the appended FIG. 12. If metal materials are used, in principle fatigue occurs. At the same time, an airplane is often loaded with small load magnitudes in many directions, but seldom with high load magnitudes. Accordingly, the fatigue with the smaller loads which often occur must be taken into consideration to a greater extent than with rare high loads. As a result, the static construction, owing to fatigue, allows significantly lower levels of stress than in the event of a failure of stability. Consequently, metal structures can be constructed for stability below the limit load (LL). The post-buckling region can advantageously be included.

With composite fiber materials, no slow fatigue occurs; such composite fiber materials can instead fail abruptly in the event of the occurrence of inadmissible overloads. With composite fiber materials, there is no reduction of the static strength levels owing to fatigue, as occurs with metal materials. Accordingly, an identical structure cannot make use of the post-buckling region to the same extent if it is constructed with a fiber composite. Ultimately, this construction method is thereby impaired and loses a significant proportion of its advantages.

An object of the invention is to improve a surface component for an aircraft and a production method therefor in such a manner that a surface component with universally possible selection of materials and also possible composite fiber material can be operated for the shell with significantly increased tolerable loads or can be produced with the same carrying force with considerably reduced mass.

This object is achieved with a surface component for an aircraft having the features of claim 1 and a production method having the features of the independent claim.

Advantageous embodiments of the invention are set out in the dependent claims.

According to a first aspect, the invention makes provision for a surface component for an aircraft, having at least one shell and a reinforcement grid structure, characterized in that the shell has a preliminary buckling structure which, under a load which acts on the shell in a direction parallel with the shell, brings about a buckling of the shell in a predetermined direction.

It is preferable for at least the shell to be formed from composite fiber material.

It is preferable for the composite fiber material to be constructed in an asymmetrical manner with respect to a central face of the shell in order to positively support or completely initiate the buckling under load.

It is preferable for the shell to have an arrangement of redirection regions, in which the shell is redirected toward a transverse direction.

It is preferable for the reinforcement grid structure to be arranged at one side of the shell and for the preliminary buckling structure to be constructed in such a manner that the shell buckles under load at first in a direction toward the reinforcement grid structure into a region between reinforcement profile-members.

It is preferable for the reinforcement grid structure to be constructed in such a manner that the shell buckles at skin fields which are each surrounded by the reinforcement grid structure under load substantially only with a buckling half-wave.

It is preferable for the skin fields to be constructed in a triangular and/or hexagonal and/or substantially square manner.

According to another aspect, the invention makes provision for a primary structure or fuselage section and/or supporting surface section, in particular for an aircraft, which section is at least partially formed from or with at least one or more such surface components.

According to another aspect, the invention makes provision for a method for producing a surface component for an aircraft, having

a) production of a shell and

b) production of a reinforcement structure for reinforcing the shell,

wherein step a) comprises the step of:

a1) forming the shell with a preliminary buckling structure in such a manner that the shell buckles in a predetermined direction under a load acting in the direction of the shell plane.

It is preferable for the step a) to comprise:

producing the shell with a composite fiber construction method.

It is preferable for the step a) to comprise:

asymmetrical arrangement of fiber structures in order to construct one shell half in a more rigid manner than the other shell half and thus to positively support or initiate the preliminary buckling structure.

It is preferable for the step a) to comprise:

constructing the shell with at least one redirection or an arrangement of redirections of the shell in a direction in order to thus form the preliminary buckling structure.

A basic notion of the invention is to use the post-buckling region with any material selection and in particular also for surface components with a composite fiber construction in order to thereby significantly increase the tolerable loads and consequently to achieve considerably reduced masses with the same carrying force.

In comparison with a “perfect structure”, where the shell is constructed so as to be smooth and to have a predetermined curvature over the entire extent or in a correspondingly planar manner and is provided with monolithic properties, the surface component according to the invention is provided with a selective preliminary buckling structure which brings about a preliminary buckling action or a predetermined buckling of the shell at least when the structure is loaded.

For example, slight imperfections in the form suitable for desired influence on the buckling are already introduced in the shell during production. For example, the shell may already be constructed during production in such a manner that it already buckles slightly in a non-loaded state. Additional buckling in the event of loading in the same direction is thereby predetermined.

Alternatively, a desired buckling under load may be achieved by means of a selectively chosen asymmetrical material structure, for example, selectively chosen asymmetrical structure of fiber composite layers. For example, asymmetrical structure of fiber composite layers may bring about a connection of the bending and membrane properties. A preliminary buckling could thereby be provoked by bending with an increasing load, which bending again complies with the corresponding effect of the above-mentioned imperfections.

A surface structural element having a shell and reinforcement grid structures may have, for example, in the case of a shell provided with imperfections, an appearance similar to the outer skin of a golf ball having indentations.

The shell can be configured in such a manner that it becomes deformed, for example, immediately inward toward the grid structure, by the selective preliminary buckling or a structure of a shell in such a manner that it becomes deformed in a desired manner in the event of loading on the surface component with a load in the surface plane of the surface component.

An abrupt reversal of the buckling from one direction to the other is thereby prevented. Abrupt loads on the shell are thereby prevented.

This has particular advantages during the construction of the shell with a fiber composite construction. However, the invention is not limited to the construction of the shell with a fiber composite construction; instead, the selective construction with preliminary buckling structures may also have advantages for construction with other materials.

The reinforcement grid structures are particularly preferably provided in such a regular manner that the skin fields defined between the reinforcement structure rods have a predefined buckling shape under load. A buckling shape can best be predicted when the skin field is geometrically defined in such a manner that it buckles substantially only with a buckling half-wave in one direction. In other words, only one main maximum and, if possible, no inflection points in the buckling are evident on average through a shell which is buckled under load. The term “substantially” is intended to mean here that relatively small deviations which occur in practice from the perfect buckling half-wave are not detrimental such as, for example, the occurrence of a second buckling having a substantially smaller magnitude than the main buckling.

Such a predictable buckling structure having substantially only one buckling half-wave can be achieved only with great difficulty with the conventional frame/stringer construction method which is shown in FIG. 12 and which produces substantially elongate, rectangular skin fields; in the case of reinforcement grid structures having triangular, hexagonal or substantially square skin fields, however, the buckling shapes can be predicted very well. Therefore, such reinforcement grid structures are preferred.

Reinforcement grid structures—also referred to below as grid structures—having triangular and/or hexagonal and/or square skin fields behave, in structural/mechanical terms with respect to buckling, significantly differently from structures which are reinforced in a rectangular, elongate manner, such as the frame/stringer construction method. In the case of structures which are reinforced in an elongate, rectangular manner, it is often possible for the buckling shape, that is to say, the number of buckling half-waves occurring, to be predicted only with difficulty or not at all. In the case of grid structures, however, they can be predicted with great reliability. Grid structures are substantially dependent only on the shape or geometry and the load direction.

At the same time, the buckling shape can be greatly influenced by suitable shaping of the reinforcement profile-members.

Furthermore, such grid structures having skin fields which are reinforced in a triangular, hexagonal or square manner are substantially less sensitive with respect to geometric imperfections in the shell. A “preliminary buckling” of the shell or the skin field brought about, so to speak, in a technical production manner with a given maximum magnitude—given in per cent of the skin thickness or shell thickness—particularly results in grid structures in a significantly smaller reduction of the initial buckling of the skin fields than in the case of frame/stringer structures. Calculations have found that the entire structure of the surface component in the post-buckling region, on the one hand, benefits from such imperfections rather than the carrying capacity being reduced. The buckling of the reinforcement profile-members following the initial buckling of the skin occurs at a later time with increasing imperfection. The complete collapse of the structure in the case of an even higher load is also influenced only to a small extent.

In a preferred embodiment of the invention, it is preferable for those reasons mentioned regarding the predictability of the buckling shape and the lesser sensitivity with respect to imperfections, for imperfections of relatively small magnitude already to be introduced during production in the shape suitable for the desired influence on the buckling in a selective manner in a grid structure having a predictable buckling shape. For example, imperfections having approximately 10% of the skin thickness or shell thickness are introduced. This would result, for example, in the case of a shell thickness or skin thickness of 2 mm in imperfections of approximately 0.2 mm. Alternatively, a desired buckling behavior may also be achieved by the targeted, selective, asymmetrical material structure of the shell already mentioned above.

This is brought about in the fiber composite construction method, for example, by an asymmetrical structure of fiber reinforcement layers. However, other reinforcement materials may also be added or removed in a selective manner.

Consequently, advantageous embodiments of the invention provide a number of particular advantages:
It is possible to bring about a fiber composite construction method which can—similarly to the metal structures previously—again “actively” make use of the post-buckling region without generally reducing the permanent carrying load and which therefore achieves a smaller weight.
The preliminary buckling structure—for example, obtained by redirections and/or imperfections—results in, on the one hand, the dynamic effects of the abrupt deformation during local buckling being dispensed with and a continuous redirection of the shell being brought about with increasing load. On the other hand, the structure of the surface component as a whole appears to withstand even higher loads as a result of buckling of the reinforcement profile-members occurring at a later time in the case of an already-buckled shell.
According to calculations, the imperfections or other preliminary buckling structures lose influence in the post-buckling region in the case of higher loads. The rigidity increases and load levels similar to those in the perfect structure are achieved again.
The imperfections for which small geometric dimensions are also adequate do not significantly influence the air resistance in the case of structures subjected to flow such as, for example, the fuselage of an aircraft.
As a result of the surface component according to the invention or one of the advantageous embodiments thereof, it is again possible to achieve a distinction between frequent but small load magnitudes and rare but high load magnitudes; the configuration philosophy for stability failures may be changed accordingly.

The surface components are preferably configured in such a manner that the connection of profile-members of the reinforcement grid structure to the shell—which forms, for example, the outer skin—and the connection in the region of intersections of the profile-members selectively take up the bending and torsion actions brought about by the imperfections. This may require a different connection or a reinforcement in this region depending on the configuration. For example, particular attention is paid to local fatigue, for example, of adhesive connections with respect to profile-member end-pieces, in the configuration of the surface component.

The surface components should preferably be used at locations where it is determined that high loads—high load magnitudes—occur significantly less often than small loads—small load magnitudes. Accordingly, hard landings, extreme maneuvers, etc., should occur in aircraft significantly less than small loads. In the field of aircraft, the surface components described here are suitable in this regard for the construction of surfaces of relatively large air carriers rather than for small airplanes which are constructed for aerobatic flights in order to mention only a small number of extreme examples.

In a particularly preferred manner, the described selective formation of imperfections in grid-reinforced structures is provided so as to have—according to the current state of knowledge—triangular and/or hexagonal and/or substantially square skin fields. In other words, the formation of imperfections is preferred for such skin field shapes in which substantially only one buckling half-wave is produced. Selective geometric imperfections which are formed in a technical production manner (preliminary buckling structures) are particularly suitable for such structures having a rather secondary character with regard to lift and resistance of flow, that is to say, for example, for fuselages, pressure bulkheads, intermediate floors or internal components or the like. Preliminary buckling structures which have a smooth outer skin are preferred for supporting surfaces or other outer faces having a particular weight on flow shapes. This may be achieved in particular by internal measures such as, for example, an asymmetrical laminate construction with fiber composite materials.

A peculiarity of the preliminary buckling structure in the surface component according to the invention is that the stability of the shell may be selectively weakened by such preliminary buckling structures. Consequently, the structure of the surface component is selectively weakened at first by the preliminary buckling structure in order, however, subsequently to be able to withstand substantially higher loads.

This has no precedent until now. Although there is the generally known teaching, in the field of metal construction or for pipes or bottles, of generally reinforcing the shell by means of selective redirections, such as beads or grooves or the formation of hexagonal structures, such methods for reinforcing shells by means of formed redirections have precisely the opposite intention to that of the teaching described in this instance. In the case of the known reinforcements by means of beads, grooves, folds, impressions or the like, a deformation reinforces a non-reinforced structure. In the surface component described here, however, the rigidity of an already-reinforced structure is reduced in order to influence the stability behavior in accordance with individual desires.

Embodiments of the invention are explained in greater detail below with reference to the appended drawings, in which:

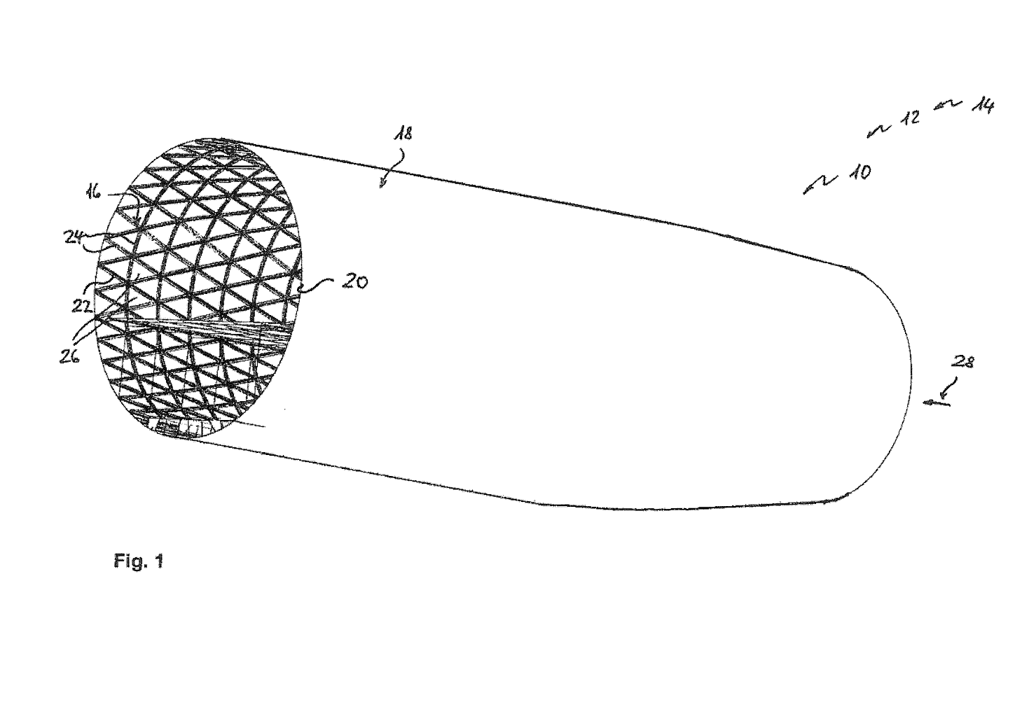

FIG. 1 is a schematic illustration of a portion of a fuselage of an aircraft, which fuselage is formed from surface components which have a shell and a reinforcement grid structure;

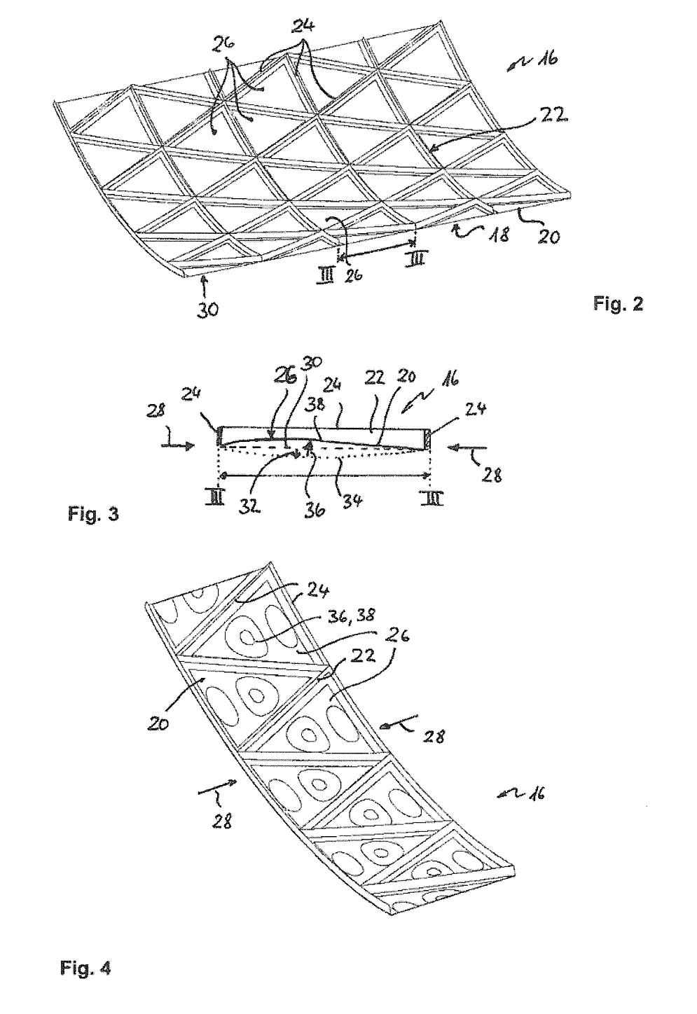

FIG. 2 shows a surface component in the form of a cut-out of the fuselage of FIG. 1 in the non-loaded state as a perfect structure for illustrating a problem to be solved;

FIG. 3 is a section through a skin field of the surface component of FIG. 2 with an indication of buckling behavior under load;

FIG. 4 shows a part-region of the surface component of FIG. 2 and a surface component according to the invention under load;

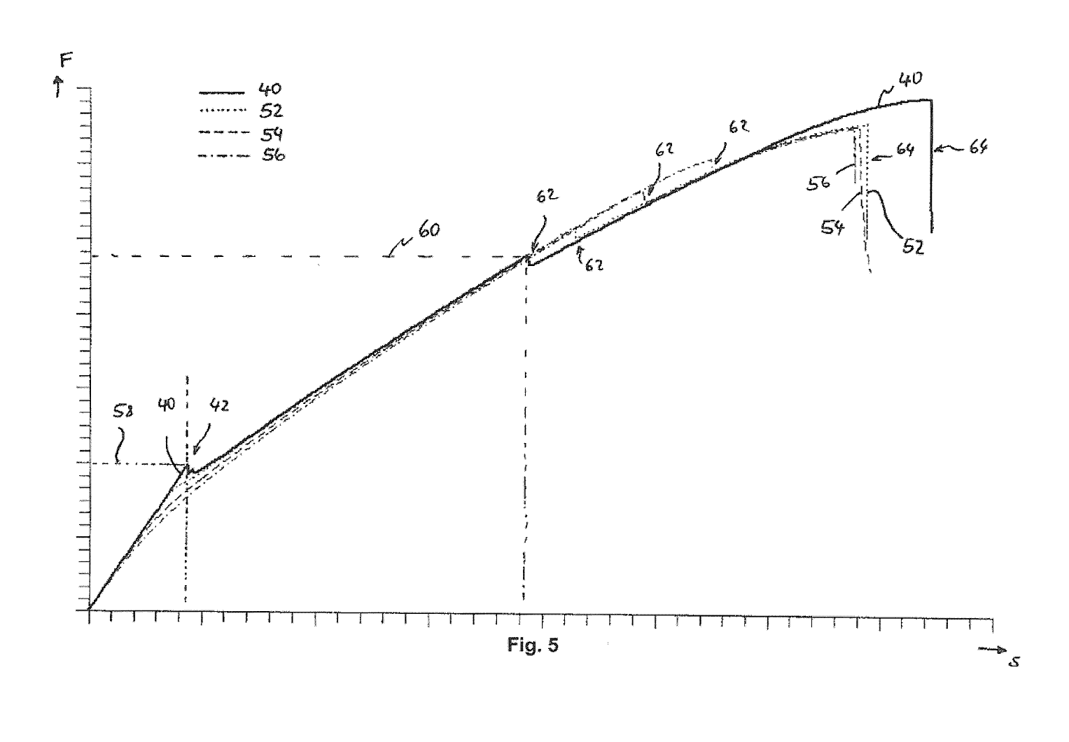

FIG. 5 is a force/displacement graph of a curved, triangle-reinforced surface component structure with axial compression (for example, the structure of FIG. 2), a perfect structure being compared with various embodiments of preliminary buckling structures;

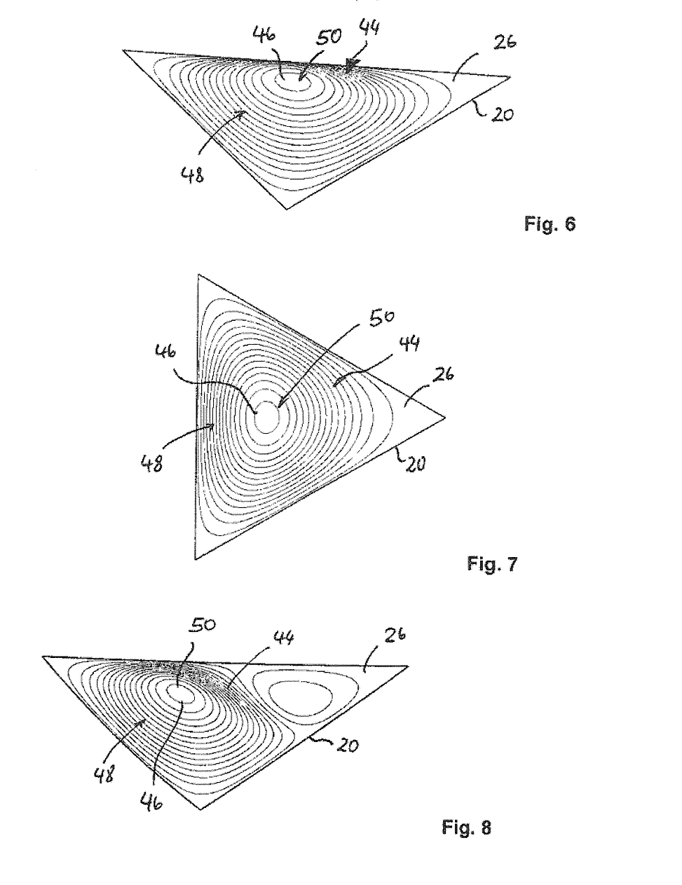

FIG. 6 is a perspective illustration of a skin field of the surface component of FIGS. 2 and 4 having a preliminary buckling structure according to a first embodiment;

FIG. 7 is a top view of the skin field of FIG. 6;

FIG. 8 is a perspective illustration of the skin field with another embodiment of the preliminary buckling structure;

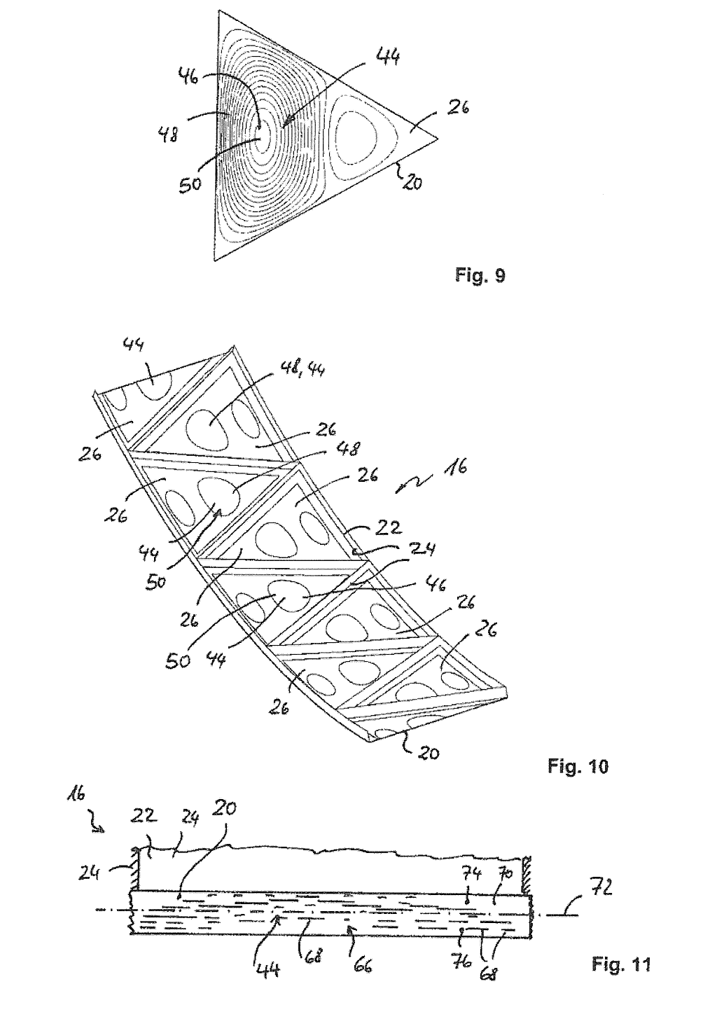

FIG. 9 is a top view of the skin field of FIG. 8;

FIG. 10 shows an embodiment of a surface component according to the invention having preliminary buckling structures;

FIG. 11 is a section through a skin field of a surface component having a preliminary buckling structure according to another embodiment;

FIG. 12 is a top view of a surface component with the conventional frame/stringer construction method; and

FIGS. 13 to 17 show different embodiments of surface components having particularly suitable reinforcement grid structures; and

FIG. 18 is a schematic illustration of an aircraft in which primary structures are constructed with surface components according to the invention.

FIG. 1 illustrates a portion of a fuselage 10 of an airplane 12 as an example of an aircraft 14, which portion is formed from several sections. The fuselage 10 is formed in a substantially cylindrical manner and from surface components 16 which have a shell 20 which forms the outer skin 18 of the fuselage 10 and an internal reinforcement grid structure 22.

The reinforcement grid structure 22 is formed from profile-members 24 which are arranged in a uniform triangular structure so that triangular skin fields 26 of the shell 20 are formed between the profile-members 24. For further details relating to the fundamental structure of the surface component 16 and the reinforcement grid structure 22 and possible connections between the profile-members 24 and the shell 20, reference may be made to DE 10 2009 056 995 A1, DE 10 2009 056 996 A1, DE 10 2009 056 997 A1 and DE 10 2009 057 018 A1.

Reference may further be made to DE 10 2009 057 006 A1 and DE 10 2009 057 009 A1 for further details relating to the production of such surface components.

All these documents are incorporated herein by reference.

A surface component 16 of the fuselage 10 is schematically illustrated in FIG. 2. As can be seen therein, the shell 20 is reinforced at one side, that is to say, the inner side in this instance, with the reinforcement grid structure 22, the profile-members 24 of the reinforcement grid structure 22 being arranged in the form of a triangle here as an example so that the shell 20 is divided into triangular skin fields 26 in the regions between the profile-members 24.

During typical operation of the aircraft 14, the surface component 16 is subjected to many relatively small dynamic loads having a relatively small magnitude and only a very small number of relatively high loads having a relatively great magnitude.

In the previously known reinforcement grid structures 22 (see the above-mentioned publications), if the shell 20 and/or the entire surface component 16 is constructed from fiber composite materials, the structure of the surface component 16 is configured in such a manner that the possible loads occurring during operation do not result in buckling of the shell 20.

As FIG. 2 shows, the shell 20—except for the curvature of the outer skin 18 of the fuselage 10—is constructed so as to be smooth and even and consequently forms a “perfect structure” which is configured so that the loads occurring can be taken up without the shell 20 and/or the surface component 16 buckling.

FIG. 3 is an exaggerated illustration of what happens in such a structure with increasing axial loading (axial in relation to the axis of the fuselage 10, that is to say, in a direction parallel with the main face of the shell 20).

FIG. 3 illustrates a skin field 26 of the surface component 16 in accordance with the section of FIG. 2 with increasing axial load 28. The broken line shows the perfect shell 30 without any loading. In previous structures of surface components 16, those structures are configured in such a manner that, for typical loads up to the limit load, the perfect shell 30 substantially retains that position illustrated with the broken lines in FIG. 3 or buckles slightly outward initially in accordance with the arrow 32 in the skin field 26; consequently, the arrow 32 represents a (slight) buckling outward. That outward buckling 32 is also indicated by the dotted line 34. If the load 28 is further increased, the shell of the skin field 26 is redirected inward from the shape shown at 34 and is then increasingly buckled inward, as indicated by the solid line 36.

FIG. 4 shows a portion of the surface component 16 under an axial load 28 from FIG. 2 with skin fields 26 which are buckled inward correspondingly.

FIG. 5 is a force/displacement graph for the surface component 16 illustrated in FIG. 4 with an increasing axial load, wherein the force F is set out on the y axis and the path s of the deformation of the surface component 16 in an axial direction is set out on the x axis. More specifically, F designates the load in an axial direction at the introduction location and s designates the displacement of the introduction location in an axial direction under the influence of that load.

The solid line shows the perfect structure as indicated in FIG. 2, the shell 20—perfect shell 30—being constructed accordingly so as to have a smooth surface and to be even. That force/displacement line 40 of the perfect structure has at 42 an abrupt drop which indicates the sudden change 42 from the non-deformed shell 30 illustrated in FIG. 3 or the slightly outwardly buckled shell 34 toward the buckling 36 inward.

Whereas, for a configuration of the surface component 16 from metal materials, such bucklings 32, 36 may result in occurrences of material fatigue, but are otherwise non-critical for metals, such a change must be considered to be more critical in the case of fiber composite structures and must be prevented wherever possible. For that reason, as already explained above, current surface components 16 constructed from fiber composite materials are configured in such a manner that the loads up to the limit load 58 do not result in corresponding post-buckling.

The jump indicated at 62 indicates the start of the buckling of portions of the reinforcement grid structure and, at the right-hand end, the clear descent of the line shows the collapse 64 of the structure.

In contrast, FIGS. 6 and 7 show the skin field 26 for the structure of the surface component 16 in accordance with FIGS. 2 and 4, the skin field 26 being provided with a preliminary buckling structure 44 which causes the shell 20 to buckle in a predetermined direction under an axial load 28 at the skin field 26.

In the embodiment of FIGS. 6 and 7, the preliminary buckling structure 44 has a redirection 46 of the shell 20 inward as far as the reinforcement grid structure 22. Consequently, the shell 20 is no longer the shell 30 having a perfect structure which is uniform and even and instead the shell 20 has imperfections 48 in the form of the redirection 46 at the skin fields 26 or, in other words, in the form of a preliminary buckling 50 in the desired direction. Consequently, the shell 20 of the skin field 26 is already buckled inward in the direction of the arrow 36 of FIG. 3 to a given extent in the unloaded state.

When the shell 20 is configured, a few percent of the thickness of the shell 20 may be assumed to this end for the magnitude of the buckling 36 inward. The inwardly buckled shell 38 of FIG. 3 would consequently show a highly exaggerated illustration of the preliminary buckling 50 and the redirection is intended to be selected to be smaller in practice.

The dotted line in FIG. 5 shows, for example, the force/displacement line 52 for a surface component 16 having imperfections 48 to an extent of 5% of the thickness of the shell 20. The broken line shows a force/displacement line 54 having imperfections of 20% of the shell thickness; and the dot-dash line is a force/displacement line 56 having imperfections of 50% of the shell thickness.

A comparison of the lines 40, 52, 54, 56 shows that the perfect structure having the perfect shell 30 can be operated only up to a limit load 58, where the abrupt change 42 takes place and where the shell 20 begins to buckle inward.

Another jump 62 in the line 40 indicates the maximum, ultimate load 60 with which the perfect structure can be loaded. The jump 62 indicates the time at which the reinforcement grid structure 22 begins to buckle (bend) and when a mode change occurs in the shell 20, 30. The abrupt drop at the end of the lines indicates the collapse 64 of the structure of the surface component 16. The entire panel formed by the surface component 16 buckles in this instance.

A comparison of the force/displacement line 40 of the perfect structure, on the one hand, and the force/displacement lines 52, 54, 56 having imperfections 48 in the shell 20 shows that the surface components 16 having the preliminary buckling structures 44 can also be operated in a range which is after the limit load 58 for the perfect structure. In particular, the lines 54, 56 having imperfections in the order of magnitude of 20% or 50% of the shell thickness have in large areas shallowly curved lines without jumps.

Accordingly, the surface components 16 having the preliminary buckling structures 44 can also be operated in the post-buckling range even when using fiber composite materials for the shell 20. Higher loads can be taken up for the same weight, or the same loads can be taken up with a structure having a lower weight.

This is particularly advantageous during construction with fiber composite materials but may also provide advantages in surface components of other materials.

The surface components 16 having the construction according to the invention also take up the shape shown in FIG. 4 under load; this can be achieved in a readily predictable manner without abrupt changes 42.

FIGS. 8 and 9 show the skin fields 26 with other embodiments of the preliminary buckling structures 44, the shape of the preliminary buckling 50 being selected to be different.

FIG. 10 shows a surface component 16 having the shell 20 and the reinforcement grid structure 22, the skin fields 26 between the profile-members 24 being provided with the preliminary buckling structures 44 according to FIGS. 8 and 9. FIG. 10 shows the non-loaded state and FIG. 4 shows the loaded state of that surface component 16.

Instead of the imperfections 58, however, the preliminary buckling structure 44 may also be constructed in a different manner. The important aspect for the preliminary buckling structure 44 is a desirable redirection behavior under load. This can be achieved by different steps in terms of the structure and construction of the shell 20.

FIG. 11 is a section through a skin field 26 showing the inner structure of the shell 20 from fiber composite materials 66 having a plurality of layers of fibers 68 which are embedded in a plastics matrix 70. The fiber layers 68 are constructed in a non-symmetrical manner in relation to the central face 72 of the shell 20 so that the skin field 26 buckles under load in a direction, that is to say, preferably inward. To this end, for example, there are provided in a region (for example, central region) of the skin field 26 more fibers 68 in the first half 74 of the shell 20 which is notionally divided by the central face 72 and fewer fibers 68 in the second half 76, whereas fewer fibers 68 are provided in another region (for example, further outward) in the first half 74 and more fibers 68 in the second half 76 of the shell 20.

The step shown of providing the shell 20 with preliminary buckling structures 44 has advantages particularly at locations where buckling of the shell 20 under load can be predicted or calculated in a defined manner.

FIG. 12 shows a conventional frame/stringer construction method of a known surface component, a reinforcement structure 82 being formed by frames 84 and stringers 86 so that elongate, rectangular skin fields 88 result.

In the case of elongate skin fields 88, not only one (main) buckling half-wave may be formed under load, as indicated, for example, in FIG. 6 or FIG. 3, but instead a plurality of buckling half-waves may be formed in different directions.

However, FIGS. 13 to 17 show reinforcement grid structures 22 having skin fields 26 in which substantially only one buckling half-wave is formed.

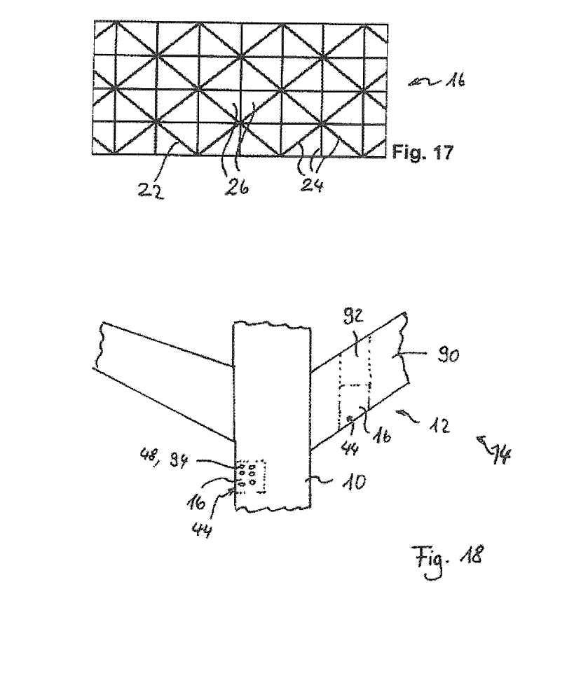

FIG. 13 shows a reinforcement grid structure 22 having a substantially square skin field 26; FIG. 14 shows the already-indicated, triangular shape of the reinforcement grid structure 22 having the triangular skin field 26; FIG. 15 shows a combination of square and triangular skin fields 26; FIG. 16 shows a combination of triangular and hexagonal skin fields 26 and FIG. 17 shows a reinforcement grid structure 22 having another shape of triangular skin fields 26.

The preliminary buckling structures 44 are particularly suitable for all the reinforcement grid structures 22 shown in FIGS. 13 to 17.

If the preliminary buckling structures 44 are formed by the redirections 46 of the shell 20, a few concave regions 94 are formed in the outer skin 18, as indicated in FIG. 18. Since the redirections 46 are only small, however, this has no effect or only very little effect on the aerodynamic properties of the fuselage 10. Therefore, such surface components 16 having external imperfections 48 are readily suitable for outer skin regions of aircraft 14 which are non-critical in dynamic flow terms such as, for example, the fuselages 10.

However, the surface components 16 having preliminary buckling structures 44 may also be used in the region of outer skin faces of an aircraft, which faces are effective in mechanical flow terms, such as, for example, a supporting surface 90 (indicated in FIG. 18). To this end, there may preferably be considered preliminary buckling structures 44 which are implemented by means of internal material measures such as, for example, the asymmetrical distribution of fibers 68 indicated in FIG. 11, in order to form supporting surface sections 92.

During the production of the surface components 16, the preliminary buckling structures 44 are also already produced during the production of the shell 20. Otherwise, the production is carried out as in the above-mentioned documents DE 10 2009 013 511 A1, DE 10 2009 013 585 A1, DE 10 2009 048 748 A1, DE 10 2009 056. 994 A1, DE 10 2009 056 995 A1, DE 10 2009 056 996 A1, DE 10 2009 056 997 A1, DE 10 2009 056 998 A1, DE 10 2009 056 999 A1, DE 10 2009 057 006 A1, DE 10 2009 057 009 A1, DE 10 2009 057 010 A1 and/or DE 10 2009 057 018 A1. Connection locations between profile-members 24 relative to each other and/or between profile-members 24 and the shell 20 may be reinforced in this instance.

The buckling behavior can be even further influenced by selecting suitable profile shapes for the profile-members 24 and in particular the shape of the reinforcement grid structures 22.

### LIST OF REFERENCE NUMERALS

10 Fuselage

12 Airplane

14 Aircraft

16 Surface component

18 Outer skin

20 Shell

22 Reinforcement grid structure

24 Profile-member

26 Skin field

28 Axial load

30 Perfect shell

32 Buckling outward

34 Outwardly buckled shell

36 Buckling inward

38 Inwardly buckled shell

40 Force/displacement line of the perfect structure

42 Abrupt change

44 Preliminary buckling structure

46 Redirection

48 Imperfections

50 Preliminary buckling

52 Force/displacement line with imperfections of 5% of the shell thickness

54 Force/displacement line with imperfections of 20% of the shell thickness

56 Force/displacement line with imperfections of 50% of the shell thickness

58 Limit load

60 Ultimate load

62 Jump

64 Collapse

66 Fiber composite material

68 Fibers

70 Plastics matrix

72 Central face

74 First half

76 Second half

80 Known surface component

82 Reinforcement structure

84 Frame

86 Stringer

88 Elongate skin field

90 Supporting surface

92 Supporting surface section

94 Concave regions

F Force—here: axial compression load at introduction location

s Path—here: displacement of introduction location of load in axial direction

1. A surface component for an aircraft, having at least one shell and a reinforcement grid structure,
wherein
the shell has a preliminary buckling structure which, under a load which acts on the shell in a direction parallel with the shell, brings about a buckling of the shell in a predetermined direction.

2. The surface component as claimed in claim 1, wherein the shell is formed from composite fiber material.

3. The surface component as claimed in claim 2, wherein the composite fiber material is constructed in an asymmetrical manner with respect to a central face of the shell in order to bring about the buckling under load.

4. The surface component as claimed in claim 1, wherein the shell has an arrangement of redirection regions, in which the shell is redirected toward a transverse direction.

5. The surface component as claimed in claim 1, wherein the reinforcement grid structure is arranged at one side of the shell and the preliminary buckling structure is constructed in such a manner that the shell buckles under load at first in a direction toward the reinforcement grid structure into a region between reinforcement profile-members.

6. The surface component as claimed in claim 1, wherein the reinforcement grid structure is constructed in such a manner that the shell buckles at skin fields which are each surrounded by the reinforcement grid structure under load substantially only with a buckling half-wave.

7. The surface component as claimed in claim 6, wherein the skin fields are constructed in a triangular and/or hexagonal and/or square manner.

8. A fuselage section and/or supporting surface section for an aircraft, which section is at least partially formed from or with at least one or more surface component(s) as claimed in claim 1.

9. A method for producing a surface component for an aircraft, having
a) production of a shell and
b) production of a reinforcement structure for reinforcing the shell, wherein step a) comprises the step of:
a1) forming the shell with a preliminary buckling structure in such a manner that the shell buckles in a predetermined direction under a load acting in the direction of the shell plane.

10. The method as claimed in claim 9,
wherein the step a) comprises:
producing the shell with a composite fiber construction method.

11. The method as claimed in claim 10,
wherein the step a) comprises:
asymmetrical arrangement of fiber structures in order to construct one shell half in a more rigid manner than the other shell half and thus to form the preliminary buckling structure.

12. The method as claimed in claim 9,
wherein the step a) comprises:
constructing the shell with an arrangement of redirections of the shell in a direction in order to thus form the preliminary buckling structure.
